(19) United States
(12) Patent Application Publication
(10) Pub. No.: US 2011/0151241 A1
(43) Pub. Date: Jun. 23, 2011

(54) FORMED MATERIAL FOR VEHICLE INTERIOR COMPONENT

(75) Inventor: Masahiko Mikami, Hiroshima (JP)

(73) Assignee: SANWA KOGYO CO., LTD., Hiroshima (JP)

(21) Appl. No.: 13/061,794

(22) PCT Filed: Aug. 21, 2009
(86) PCT No.: PCT/JP2009/065207

§ 371 Date: Mar. 2, 2011

(30) Foreign Application Priority Data
Sep. 11, 2008 (JP) 2008-233857

(51) Int. Cl. B32B 3/26; B32B 7/12

(52) U.S. Cl. 428/317.7

(57) ABSTRACT

A formed material for a vehicle interior component is provided in which a base material is integrated with glass paper, formed by a wet process, subjected to optimal treatment for allowing it to exhibit strong affinity with a urethane based adhesive, which has practical bending strength, and in which the amount of used glass fiber reinforced material is reduced when compared with glass mat to achieve weight reduction. Specifically, the formed material for a vehicle interior component includes a base material layer 11 of rigid urethane, first and second glass fiber reinforced layers 12, 14 bonded on the opposite sides thereof, a surface layer 13 bonded on the exterior of the first glass fiber reinforced layer 14, and a reverse layer 15 bonded on the exterior of the second fiber reinforced layer 15. At least the first glass fiber reinforced layer 12 is glass paper of glass fiber filaments. A silane based treatment agent of silane or a silane mixed agent with which urethane emulsion is mixed is used as a treatment agent for the paper.

### TECHNICAL FIELD

The present disclosure relates to formed materials for vehicle interior components, such as formed ceilings for vehicles, formed door trims, rear package trays, tonneau boards, floor materials for vehicles, sunshades, and the like.

### BACKGROUND ART

Conventionally, as one of formed materials for vehicle interior components, a material for, for example, a formed ceiling has been known in which glass fiber reinforced layers are provided on the opposite sides of a base material made of rigid urethane or the like and a surface layer and a reverse layer are respectively provided on the exteriors of the reinforced layers (see Patent Document 1).

In this case, the glass reinforced layers are formed of glass mats or the like provided on the opposite sides of the base material in a sandwiched manner. The glass mats are applied (impregnated) by an adhesive made of urethane based resin (e.g., isocyanate based resin) for reinforcing the base material and for obtaining bonding strength with respect to the surface layer and the reverse layer. As the surface layer, non-woven fabric, lamination layer of tricot and slab urethane, fabric, knit, plastic sheets, and the like have been used.

The glass mats herein means, as is generally known, glass mats obtained in the following manner. After about 80 glass filaments having a diameter of about 10 to 15 μm are bundled, such fiber bundles (so-called roving) having a diameter of 0.8 to 1.5 mm are formed by using a sizing agent, and are cut to have a length of about 50 mm, thereby forming chopped strands. Then, the chopped strands are scattered in a mat shape by using a binder.

In the case of a ceiling whose base material is made of urethane, in general, its rigidity is ensured by the base material and the glass mats adhered to the opposite side surfaces of the base material and functioning as glass fiber reinforced layers. Further, the rigidity is not a mere sum of the three. Where a sandwiched structure in which thin films incapable of being stretched are provided on the surfaces of a base material is formed by bonding glass mats incapable of being stretched by external force to the respective surfaces of a base material having a given thickness, the rigidity of its entirety is ensured by ensuring resistance to deformation at the respective surfaces of the base material.

As the glass fiber reinforced layers, a layer has been known, for example, in which glass fiber chops (cut roving glass), the glass fiber mat, or glass fiber cloth is/are provided on the opposite sides of a core material made of polyurethane foam. A reverse layer and a surface layer are provided on the exteriors thereof (see Patent Document 2).

Further, a layer has been known in which glass fiber in the form of glass paper is provided, in place of the glass fiber mat, on the opposite sides of a base material formed with a polyurethane foam layer with the use of a hot melt film adhesive (see Patent Document 3).

### CITATION LIST

### Patent Document

PATENT DOCUMENT 1: Japanese Unexamined Patent Application Publication No. 2001-301539
PATENT DOCUMENT 2: Japanese Unexamined Patent Application Publication No. 2002-046545
PATENT DOCUMENT 3: Japanese Examined Utility Model Registration Application Publication No. 5-34278

### SUMMARY OF THE INVENTION

### Technical Problem

According to recent environmental issues, especially, for energy conservation, a needs is increasing more and more for reduction in weight of components and portions of automobiles. Lightweight ceilings for automobiles are also demanded sharply.

In general, in the above formed ceiling, for example, the urethane base material has a thickness of 6.5 mm. Each (upper and lower) glass mat as the glass fiber reinforced layers is 100 g/m². The adhesive is 15 g/m². The surface layer of non-woven fabric is 70 g/m². The reverse layer (a film and non-woven fabric) is 30 g/m². In a case of a ceiling including such a formed urethane base material, the urethane base material is about 40 weight %. A sum of the glass fiber reinforced layers and the adhesive (on the surfaces of the urethane base material) is about 45 weight %. A sum of the surface layer and the reverse layer is about 15 weight %. Weight occupation of the urethane base material and the glass fiber reinforced layers in the ceiling is very large. However, it is difficult to reduce the weight of the urethane base material because of the presence of requirements for being a core material. Therefore, of all the above materials, weight reduction of the glass fiber reinforced layers is being expected seriously.

However, the ceiling shown in Patent Document 1 mere shows the glass fiber reinforced layers as the fiber reinforced layers. Patent Document 1 is silent on weight reduction of the glass fiber reinforced layers.

Patent Document 2 shows that, in order to reduce the weight of the glass fibers, isocyanate based adhesive is impregnated in the base material in advance, and is also impregnated in the glass fiber layers in advance. Patent Document 2 further mentions that isocyanate based adhesive can exhibit strong affinity with the glass fibers, and can provide excellent reactivity, adhesiveness, and workability.

In the case where glass fiber reinforced layers using the glass fiber layers shown in Patent Document 2 are made of chopped strand glass (hereinafter referred to as a glass mat), it is expected that weight reduction to a half of the current layers may theoretically cause no problem of strength. However, it is difficult to obtain a completely uniform basis weight over the entire mat. Because, the glass mat is manufactured by the following manner. About 80 glass filaments are bundled to form bundles (roving) having a diameter of 0.8 to 1.5 mm. The bundles are cut to have a length of about 50 mm, thereby forming chopped strands. Then, the chopped strands are scattered in a mat shape by using a binder. For example, in a glass mat having a nominal basis weight of 100 g/m², as shown in FIG. 9, many thin parts having a basis weight of 50 g/m² are locally present. The lighter the weight of the glass mat is, the more this tendency may be exhibited. For this reason, the bending strength of the thin parts (see FIG. 9(B)) is about a half of that of a normal part (see FIG. 9(A)) in the above formed ceiling.

If such a thin part is applied to a portion of the formed ceiling where deformation is remarkable, such as an overhead console portion, assist grip, etc., for example, this portion may be stretched in forming to be more thin. This can result in a bending strength lower than a lower limit that the formed ceiling is required to have. Accordingly, it is generally said that an ordinary glass mat having a nominal basis weight of 100 g/m² or lower cannot be reduced in practice in view of weight variations caused through its manufacturing process.

Further, in the glass mat manufacturing process, the glass fiber bundles of, for example, about 80 glass filaments with a length of about 10 μm are cut and scattered. At that time, the cut fibers are overlapped with each other to fall in the form of brush like bundles (so-called brush like drops). This case is often observed. FIG. 10(A) is a photograph showing such a brush like drop in a glass mat. FIG. 10(B) is a photograph showing part of the surface layer peeled after forming, which is like a wheal. The formed ceiling in such a case cannot be modified, and should be disposed as it is, thereby resulting in considerable losses.

Further, FIG. 11 is a photograph showing glass fiber bundles in the form of a large glass block where part of the surface layer swelled over a large range is peeled. In the upper right part, which is the glass mat (the base material can be seen therebehind), a circular glass block is observed. In the lower left part, which is the reverse side of the surface layer, a trace of the glass block is observed on the side of the surface layer. The ceiling having such a glass block should be disposed (i.e., disposed as a defective in manufacture). This is a significant problem.

In addition, although not so significant as brush like drops as above, parts thicker than the average thickness are formed by overlapping the glass fiber bundles. When such part is applied to a portion of the formed ceiling where remarkable bending and deformation are caused, a tension larger than the usual tension naturally works on the portion in forming. Accordingly, the thick glass fiber obstructs (locally restricts stretching of the entirety) to form corrugation. Corrugation lines by the glass bundles appearing in the surface of the surface layer appear in several parts of almost all formed ceilings. This is called glass corrugation. One example of the glass corrugation is shown in FIG. 12. FIG. 12(A) is a photograph partially showing part around the front side of the formed ceiling where remarkable bending is caused. FIGS. 12(B) and 12(C) are enlarged photos when viewed at different angles of view which show part in FIG. 12(A) where glass corrugation is formed. Fortunately, this glass corrugation can become almost ignorable (i.e., disguised) by pecking the surface layer by a tip end of a needle so as to reduce the bonding strength with respect to the glass mat. However, this necessitates handwork, thereby presenting a significant problem in yields.

As such, the glass mat has some practical limits on weight reduction, and presents deficiencies of so-called brush like drops and wheals.

By contrast, when glass paper of glass fibers shown in Patent Document 3 is used, the disadvantages of the glass mat may be overcome, and weight reduction can be achieved.

However, although the use of glass paper as the glass fiber reinforced layers has been considered as in Patent Document 3 for about twenty years, reduction in practice has not been achieved.

The reason of this may be the following. That is, in the case where a formed ceiling is formed by arranging the conventional glass paper indicated in Patent Document 3 as reinforced layers on the opposite sides of a urethane base material, and providing a surface layer and a reverse layer on the exteriors thereof, if the formed ceiling is nearly in a so-called plate shape causing less displacement and deformation, reduction in practice might be able to be achieved.

However, formed ceilings for recent vehicles have large projections and depressions for sunroofs, overhead consoles, etc. Or, the formed ceilings are largely recessed as a whole. This accompanies large deformation in forming.

Therefore, in the case where the glass fiber is used as a reinforced material for a formed ceiling, whose shape requires the reinforced material to be locally displaced and deformed in forming, each material (from the surface layer to the reverse layer) must follow the displacement and deformation. However, the glass fiber reinforced member itself should not be stretched and deformed for its function (reinforcement). Accordingly, the glass fiber reinforced member follows the displacement and deformation by allowing fibers to be displaced (no displacement occurs when the adhesive is cured after forming). Thus, followability after and bending strength against deformation in forming are required.

However, when conventional glass paper is formed along a recent formed ceiling that is deformed largely, displacement of the fibers, which are short, 13 mm, following deformation in forming may break the paper, thereby resulting in useless paper. For example, when much amount of a melamine based treatment agent is used to make the paper to be hard, no displacement of fibers occurs, thereby occurring a phenomenon that the paper is cut (broken) over a large range in forming Further, when a film of a hot melt adhesive is interposed as in Patent Document 3, this film may suppress relative displacement between the glass paper and the glass filaments. The adhesion strength of the film to the glass paper and the bonding strength of the film to the base material may be insufficient. Further, the film can reduce sound absorption, thereby loosing the features of the formed ceiling formed of the urethane base material. When web hot melt (hot melt in an arachnoid shape) is employed in order to avoid this disadvantage, cost may increase and handling can become difficult, thereby lowering yield.

In view of this, the present inventor continued study for reducing glass paper into practice. In consequence, the present inventor found that conventional glass paper whose fibers are short, 13 mm, is displaced relative to each other for following deformation in forming, thereby causing partial breakage of the paper. Accordingly, glass paper was manufactured by a paper machine with glass filaments whose fiber length is long, 25 mm. At that time, a urethane based adhesive (isocyanate based adhesive) used for allowing the glass mat to adhere to the base material was used for allowing the glass paper to adhere to a urethane base material because it was expected that the base material would catch the glass fibers well. However, when the paper whose glass filaments include long fibers was used as the reinforced layers, although forming went well without breakage and cut of the glass paper, the glass paper was insufficiently bonded to the foamed urethane layer of the base material, the surface layer, and the reverse layer. Therefore, the resultant material was not satisfactory as a formed ceiling.

In view of this, the present inventor further studied with particular attention drawn to treatment agents for the glass paper then. In consequence, it was found that the isocyanate based adhesive did not catch the glass paper well. That is, the isocyanate based adhesive coated on the surface of the glass paper simply rested on the glass paper. Since no strong binding force was present between the glass filaments forming the glass paper and the adhesive, binding force between the glass paper and the isocyanate adhesive was insufficient. For this reason, the glass paper was on long way from being used as a reinforced member as an integration of the urethane base material and the glass paper.

The present inventor still further studied and searched treatment agents used in forming glass paper from glass filaments which has affinity with the isocyanate based adhesive and can catch well the glass filaments of the glass paper. Accordingly, glass paper was manufactured from glass filaments with a silane based treatment agent as an agent made of silane or silane mixed agent with which urethane emulsion and the like are mixed. The urethane base material was allowed to adhere to the glass paper with the isocyanate based adhesive. This could result in a formed ceiling in a recent shape accompanying large displacement and deformation which can exhibit good followability, excellent bonding characteristics to the formed urethane layer of the base material, the surface layer, and the reverse layer, and sufficient bending strength. In particular, when glass filaments were generated with the silane based treatment agent as a treatment agent, and glass paper was formed with the glass filaments formed with this treatment agent, the silane based treatment agent adhered to and covered the surface of the fiber filaments. Since this silane based adhesive can exhibit good adhesiveness to the isocyanate based adhesive, the isocyanate based adhesive can catch the glass filaments well. That is, the isocyanate based adhesive can not only adhere to the surface of the paper made of fibers but also catch the silane based treatment agent adhering to the fiber filaments before forming the paper. Thus, the fiber filaments are allowed to firmly adhere to the base material with the isocyanate based adhesive.

It is noted that, although filaments of glass fibers are referred to in the above discussion, the same can be applied to filaments of basalt fibers besides the glass fiber filaments. Therefore, the present invention can encompass examples of inorganic filaments, such as glass fibers and basalt fibers.

### Solution to the Problem

A formed material according to a first example is a formed material for a vehicle interior component including: a base material layer made of rigid urethane foam; first and second fiber reinforced layers bonded on opposite sides of the base material layer; a surface layer bonded on the exterior of the first fiber reinforced layer; and a reverse layer bonded on the exterior of the second fiber reinforced layer, wherein at least the first fiber reinforced layer is made of paper formed of fiber filaments, a silane based treatment agent containing silane or a silane mixed agent with which urethane emulsion is mixed is used as a treatment agent for the paper, and the paper is bonded to the base material layer with a urethane based adhesive.

According to a second example, in the first example, the paper is made of an inorganic material.

According to a third example, in the second example, the paper is made of paper of glass fiber filaments or basalt fiber filaments, and the first and second fiber reinforced layers are made of paper of glass fibers or basalt fibers.

According to a fourth example, in the first example, the treatment agent for the paper is used in forming the fiber filaments, and the paper is formed with the treatment agent used for generating the fiber filaments.

According to a fifth example, in the any one of the first to fourth examples, the fiber filaments has a diameter of 5 to 25 μm.

According to a sixth example, in any one of the first to fourth examples, the fiber filaments include long fibers having a length of 20 to 100 mm.

According to a seventh example, in the sixth example, the long fibers having a length of 20 to 100 mm are included by at least one third in the fiber filaments.

According to an eighth example, in any one of the first to fourth examples, the paper has a basis weight of 20 g/m² to 100 g/m².

According to a ninth example, in any one of the first to fourth examples, the paper is formed by mixing chemical fibers of polyethylene of 3 to 20 weight % with the fiber filaments.

According to a tenth example, in the any one of the first to fourth examples, the paper of the fiber filaments is formed by a wet process.

According to an eleventh example, in any of the first to fourth examples, the formed material for a vehicle interior component is a formed ceiling.

### Advantages of the Invention

In the first example, every part of the paper made of fibers, such as glass fibers, for example, is almost uniform when compared with a glass mat. Therefore, the adhesive can be applied nearly uniformly, thereby nearly uniformly integrating the fiber paper with the base material. In particular, since the disadvantages in glass mats, that is, brush like drops and glass blocks may not be generated, disposal of a formed ceiling after forming caused due to such disadvantages can be avoided. Further, minor adjustment for glass corrugation and the like, which may be present even though disposal can be avoided, can be eliminated. In particular, if any disadvantage in conventional glass mats, such as brush like drops and wheals appears on the side of the surface layer, merchantability is especially inferior. Therefore, the fiber paper should be provided as at least the first reinforced layer, but may be provided on the reverse side in addition. In particular, displacement effectively occurs between the filaments in the fiber paper even at portions accompanying large deformation in forming, such as an overhead console portion and the like. Therefore, the fiber paper can neither become thin nor be broken. The bending strength is satisfactory. Further, since the fiber paper is formed with the silane based treatment agent, the urethane based adhesive (isocyanate based adhesive) can catch well the fiber filaments of the fiber paper to be allowed to adhere thereto.

In the second example, the fiber paper is made of an inorganic material. Therefore, yields can increase, and thermal disposal thereof is applicable with no harm.

In the third example, the fiber paper can have high strength and be lightweight. Further, cost can be reduced with high yield.

In the fourth example, not only bonding characteristics of the fibers themselves are excellent in forming the paper, but also excellent bonding characteristics can be obtained between the base material and the paper. Further, a formed material for a vehicle interior component excellent in permeability and sound absorption can be obtained.

In the fifth example, appropriate selection of the diameter of the fiber filaments can allow the silane based treatment agent to be effectively permeated through the fiber paper. Further, well balanced catching of the silane based treatment agent by the urethane based adhesive (isocyanate based adhesive) can be achieved, thereby firmly bonding the fiber filaments to the base material.

In the sixth example, appropriate selection of the length of the fiber filaments can satisfy strength, such as bending strength, etc. that a formed material for a vehicle interior component is required to have, thereby obtaining a lightweight formed material for a vehicle interior component.

In the seventh example, the long fiber filaments having a length of 20 to 100 mm are included by at least one third, thereby facilitating forming of the paper. Further, a formed material for a vehicle interior component exhibiting high strength and excellent formability can be obtained.

In the eighth example, the basis weight of the woven fabric of the fibers is 20 g/m² to 100 g/m², which can achieve weight reduction.

In the ninth example, since the paper is formed by mixing chemical fibers of polyethylene or the like, the chemical fibers can serve as a sliding agent to allow the fiber filaments to tend to slide when compared with sliding of only fiber filaments, thereby improving formability. The chemical fibers can exhibit strong affinity with the urethane based adhesive (especially, an isocyanate based adhesive), thereby obtaining excellent adhesiveness and increasing rigidity.

In the tenth example, since the paper of the fiber filaments is formed by using the wet process (by so-called paper scooping), thereby ensuring that fiber paper with uniform thickness can be obtained with ease.

The eleventh example can ensure stable quality of a formed ceiling even having a portion accompanying large deformation in forming, such as a sunroof, an overhead console portion, etc.

The present invention discusses that the paper of fiber filaments is made by a wet process. The employment of the wet process in the present invention is the same as employment of so-called scooping performed for forming Japanese paper and the like.

The diameters of the fiber filaments used in the present invention is preferably in a usual range of 5 to 25 μm, more preferably, 10 to 20 μm. Too long fiber length of the glass filaments may cause the glass filaments to strongly resist sliding to be cut. Thus, forming may be difficult. By contrast, when the glass filaments are too short, gaps are generated among fibers by sliding in forming to break the paper. Therefore, the length is preferably in the range of 20 to 100 mm, more preferably, 25 to 50 mm, still more preferably, 30 to 40 mm. It is noted that the diameter and length of the fibers very inherently. Not all of the fibers may fall in the above numerical ranges. This means that dominant fibers fall in the above numerical ranges. Regarding the fiber length, not all the fibers may fall in the range. Short fibers out of the above range may be dominant, and the long fibers may be included partially. In this case, the long fibers is preferably included by at least one third, and more preferably is included more than one half. In the case where the shape is complicated or high strength is required, it is preferable to use only the long fibers.

When the weight of the glass paper in the present invention is light, the strength of the reinforced layers is insufficient. By contrast, when it is too heavy, only the strength is increased more than a required value, which is contrary to the purpose of weight reduction. Therefore, the weight is preferably in the range of 20 g/m² to 100 g/m², more preferably, 25 g/m² to 80 g/m².

Only silane may suffice as the silane based treatment agent used in forming the glass paper. Alternatively, a mixed agent of silane with a urethane emulsion may be used. The urethane emulsion is preferably the same as the urethane based adhesive used as the adhesive. The weight of the silane based treatment agent depends on the diameter and weight of the glass filaments, and is preferably about 10 to 20 weight % relative to the weight of the glass filaments in order to ensure appropriate binding force of the filaments and ensure affinity with the isocyanate adhesive applied in forming a ceiling.

The silane based treatment agent can catch well the surfaces of the filaments in forming the fiber filaments. Since the fiber paper is made from the fiber filaments to which the silane based treatment agent adheres, the filaments can have excellent bonding characteristics. In addition, well balanced catching of the silane based treatment agent by the urethane based adhesive (isocyanate based adhesive) can be achieved, thereby firmly bonding the fiber filaments to the base material. As a consequence, when compared with prior art materials, such as glass mats, further weight reduction can be achieved, and formability can be increased. Specific examples of a silane coupling agent used in the present invention includes coupling agents of epoxy silane, aminosilane, ureido silane, methacryl silane, vinylsilane, styrylsilane, etc. For example, a silane coupling agent disclosed in Japanese Unexamined Patent Application Publication 7-291675, a treatment agent of only silane or that obtained by emulsifying silane and isocyanate at a ratio of 8:2, and the like may be used.

In the present invention, when the weight of the urethane based resin (e.g., isocyanate based resin) as the adhesive coated on the glass paper is heavy, the resin may extrude. When it is light, the bonding strength may be insufficient. Therefore, the weight is preferably in the range of 10 g/m² to 30 g/m², more preferably 13 g/m² to 25 g/m². Examples of the surface layer include polyolefin, polyester, or polyamide based fabric or non-woven fabric, lamination layers of tricot and slab, knit, plastic sheets, and vinyl leathers. When the formed material for a vehicle interior component is used as a formed ceiling, the base material of urethane foam may have a sheet shape, of which thickness is in the range of 3 to 12 mm.

In its manufacturing method, although the glass fiber paper is manufactured and prepared in place of conventional glass mats, no remarkable difference lies in that the reinforced layers of the prepared glass fibers are overlaid with the base material, the surface layer, and the reverse layer. That is, first prepared are a base material layer of urethane foam, a first glass fiber reinforced sheet obtained by coating a urethane based resin adhesive on glass paper, a second glass fiber reinforced sheet obtained by coating the urethane based resin adhesive on glass paper, a surface layer, and a reverse layer. The first glass fiber reinforced sheet and the second glass fiber reinforced sheet are stacked on the opposite sides of the base material layer. Then, the surface layer is stacked on the exterior of the first glass fiber reinforced sheet, and the reverse layer is stacked on the exterior of the second glass fiber reinforced sheet. Thereafter, the stacked substance is put in a heated forming mold, and is heated and pressed to be integrated.

The urethane based resin adhesive may be coated (e.g., spray coated) on the sides of the urethane foam rather than on the side of the glass paper. Alternatively, it may be coated on both sides. In place of coating, the base material or the glass paper may be immersed in a liquid tank of the adhesive. Alternatively, pieces of the glass paper may be overlaid to form the reinforced layer of glass paper.

When chemical fibers of polyethylene resin or the like are mixed in forming glass paper made of glass filaments, formability and rigidity can be improved. That is, the chemical fibers function as a skidding agent in forming a formed ceiling or the like to allow the glass filaments to tend to skid when compared with the case of only the glass fibers, thereby improving formability. As a consequence, the glass paper is effectively prevented from being broken in forming. Since the chemical fibers of polyethylene resin or the like exhibits strong affinity with the urethane based adhesive (especially, isocyanate based adhesive) used as an adhesive for allowing the base material and the glass paper to adhere to each other by application to the glass paper, further firm adhesiveness can be obtained, thereby improving rigidity. Light weight of the chemical fibers is not effective, while heavy weight thereof is wasteful. Therefore, the weight of the chemical fibers is preferably 5 to 20 weight % with respect to the total weight of the glass paper. The diameter and length of the chemical fibers may be set appropriately. However, the chemical fibers having the same diameter and length as those of the glass filaments can facilitate formation of the paper.

### BRIEF DESCRIPTION OF THE DRAWINGS

FIG. 1 is a partial view of a formed ceiling for an automobile according to an example embodiment of the present invention.

FIG. 2 is an diagram explaining a stacked state of the formed ceiling used in FIG. 1.

FIG. 3 is a table that evaluates performance of Examples of the present invention and Comparative Examples.

FIG. 4 is photographs showing distribution states of glass fibers in the present invention and prior art technique.

FIG. 5 is a perspective view of a formed ceiling for a vehicle when viewed from a designed side that forms the interior of a vehicle.

FIG. 6 is photographs showing the state of a sun visor portion when viewed from the reverse side. FIG. 6(A) shows glass corrugation of a glass mat according to Comparative Example 1. FIG. 6(B) shows glass paper according to Example 2.

FIG. 7 is a cross-sectional view taken along the line A-A in FIG. 5.

FIG. 8 presents views of pinch-off scars of formed ceilings for comparison between a case of a conventional glass mat and a case glass paper according to the present invention.

FIG. 9 is enlarged photos indicating a normal portion and a thin portion of a glass mat having a nominal weight of 100 g/m² for explaining dispersion of chopped strand glass fiber bundles according to a prior art technique.

FIG. 10 is enlarged photos for explaining that a glass fiber bundle are in a brush like drop state according to a prior art technique.

FIG. 11 is a enlarged photo for explaining that a glass fiber bundles form a glass block according to a prior art technique.

FIG. 12 is enlarged photos for explaining glass corrugation generated according to a prior art technique. FIG. 12(A) is a partial photograph of a portion around a front part of a formed ceiling where bending is sharp. FIGS. 12(B) and 12(C) are enlarged photos viewed from different angles of portions where glass corrugation is generated.

### DESCRIPTION OF EMBODIMENTS

Example embodiments of the present invention will be described below with reference to the accompanying drawings. The following preferred example embodiments are mere examples, and are not intended to limit the scope of the present invention, its applicable objects, and its use.

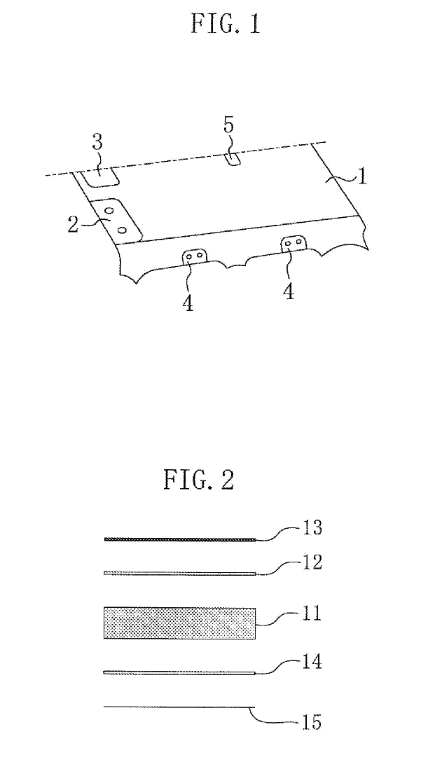

In the present example embodiment, the present invention is applied to a formed ceiling for a vehicle. FIG. 1 is a partial view of a formed ceiling according to an example embodiment of the present invention. FIG. 2 is a view explaining a stacked state in the formed ceiling used in the example embodiment in FIG. 1. In FIG. 1, the left side corresponds to the front side of a vehicle, and the right side corresponds to the rear side of the vehicle.

On both sides on the front side of a formed ceiling 1, recesses 2 (only one of them is shown) for a sun visor is formed. In the middle of the formed ceiling, an opening 3 for overhead console is formed. Though not shown, this part is largely recessed from the main plane in cross section. Reference character 4 denotes the positions of assist grips provided on the opposote sides, and 5 denotes the position of a room lamp.

As shown in FIG. 2, a glass paper layer 14 is stacked on the reverse side of a base material layer 11 made of foamed urethane. A reverse layer 15 is stacked on the exterior of the glass paper 14. On the obverse side of the base material layer 11, a glass paper layer 12 is stacked. A surface layer 13 is stacked on the exterior of the glass paper 14.

A method for manufacturing a formed ceiling according to the present example embodiment will be described next. A thermally formable rigid urethane foam sheet is prepared. Further, glass paper is prepared. The glass paper is manufactured by a paper machine of wet type by an ordinary paper manufacturing method. Specifically, glass filaments having a diameter of about 11 μm and a length of about 25 mm and covered with a silane based treatment agent are generated. This filaments are scattered and scooped to be into a paper state, thereby manufacturing the glass paper. It is noted that a silane based treatment agent may be used also in manufacturing this glass paper. Although the silane based treatment agent is preferably used in generating the filaments, as noted above, when the filaments are not required to have high strength and good formability as a formed material for a vehicle, as in the case where a formed material is simply flat, a silane based treatment agent may be used only in manufacturing the glass paper.

Further, reverse paper is prepared as the reverse layer. Processes for manufacturing a formed ceiling by using the above materials for forming will be described next. The first glass fiber reinforced sheet 12 made of the glass paper on which the isocyanate based adhesive is applied. The second glass fiber reinforced sheet 12 made of the glass paper on which the isocyanate based adhesive is applied are stacked on the opposite sides of the base material layer 11. Then, the surface layer 13 is stacked on the exterior of the first glass fiber reinforced sheet 12. On the other hand, the reverse layer 15 is stacked on the exterior of the second glass fiber reinforced sheet 14. Thereafter, the stacked substance is put in a heated forming mold, and is heated and pressed to be integrated.

### EXAMPLES

Examples will be described next where a formed ceiling is manufactured as the formed material for an interior component according to the present invention.

### Example 1

In Example 1, a thermally formable rigid urethane form sheet (1200 mm wide, 1600 mm long, and 6.5 mm thickness) with a weight per unit area of 180 g/m² having continuous foam was prepared. Non-woven fabric with a basis weight of 70 g/m² was prepared as the surface layer. An ordinary laminate of non-woven fabric and a PP (polypropylene) film with a basis weight of 30 g/m² was prepared as the reverse layer. Glass fibers were used as fibers for the first and second fiber reinforced layers. Filaments with a diameter of 11 μm and a length of 25 mm were used as a material for the glass paper. Glass filaments were generated using a silane based treatment agent (a treatment agent obtained by emulsifying silane and isocyanate at a ratio of 8:2). Glass paper was manufactured from the glass filaments. Glass fiber reinforced sheets manufactured from the glass paper set at a basis weight of 27 g/m² were prepared. An isocyanate based adhesive was applied to the glass fiber reinforced sheets at a basis weight of 15 g/m².

The materials thus prepared were arranged and stacked in a forming mold in the order of the surface layer, the first glass fiber reinforced sheet, the foamed urethane foam sheet, the second glass fiber reinforced sheet, and the reverse layer. Then, the materials were press formed in the forming mold, and were allowed to adhere to one another. After forming and adhesion, the formed substance was taken out from the forming mold, thereby obtaining a formed ceiling with a width of 1200 mm, a length of 1600 mm, and a total thickness of 7.5 mm including all the materials forming the ceiling.

### Example 2

Example 2 is different from Example 1 in a point that glass paper whose filaments has a length of 35 mm, and whose silane based treatment agent has a basis weight of 52 g/m² was prepared as the glass paper for the first and second glass reinforced sheets. The same method as in Example 1 was used for forming a formed ceiling.

### Example 3

Example 3 is different from Example 2 in a point that silane was used as a treatment agent in manufacturing the glass paper.

### Example 4

In Example 4, polyethylene resin fibers were mixed with the glass paper in forming the glass paper of Example 2. The diameter and length of the polyethylene resin fibers used were substantially the same as those of the glass filaments. In order to set the total basis weight equal to that in Example 2, 52 g/m², the basis weights of the glass paper and the polyethylene resin fibers were set at 47 g/m² and 5 g/m², respectively.

### Comparative Example 1

In order to compare with Example 1, Comparative Example 1 used conventional glass mats in place of the glass paper in Example 1. The same formed ceiling as in Example 1 was formed with a glass mat having a basis weight of 100 g/m². In other words, lightweight glass mats having a weight as light as possible was used for manufacture.

### Comparative Example 2

In order to compare with Examples 2 and 3, Comparative Example 2 used, in place of the glass paper in Example 2, conventional glass mats whose surface sides have a basis weight of 100 g/m² and whose reverse sides have a basis weight of 230 g/m² for increasing bending strength. The same formed ceiling as Comparative Example 1 was formed with these conventional glass mats.

### Comparative Example 3

In order to compare with Examples 2 and 3, Comparative Example 3 used conventional glass mats whose surface sides have a basis weight of 230 g/m² and whose reverse sides have a basis weight of 230 g/m² for further increasing bending strength when compared with Comparative Example 2. The same formed ceiling as that in Comparative Example 2 was formed with this conventional glass mats.

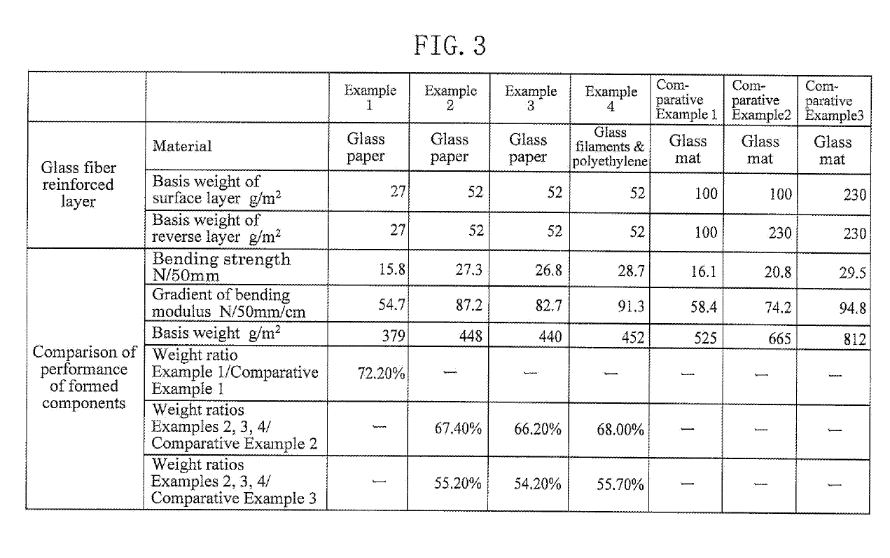

Average values of respective ten samples of Examples 1, 2, 3, 4 and Comparative Examples 1, 2, 3 are indicated. Test results of Examples 1, 2, 3, 4 and Comparative Examples 1, 2, 3 will be discussed with reference to FIG. 3.

In general, formed ceilings are required to have a bending strength of about 10 N/50 mm and a gradient of bending modulus of about 30 N/50 mm/cm. Examples 1, 2, and 3 obtained satisfactory values.

Regarding weight ratios, Example 1 to Comparative Example 1 is 72.2%. Example 2 to Comparative Example 2 is 67.4%. Example 2 to Comparative Example 3 is 66.2%. Example 3 to Comparative Example 2 is 55.2%. Example 3 to Comparative Example 3 is 54.2%. Example 4 to Comparative Example 2 is 68.0%. Example 4 to Comparative Example 3 is 55.7%. Thus, considerable weight reduction could be achieved.

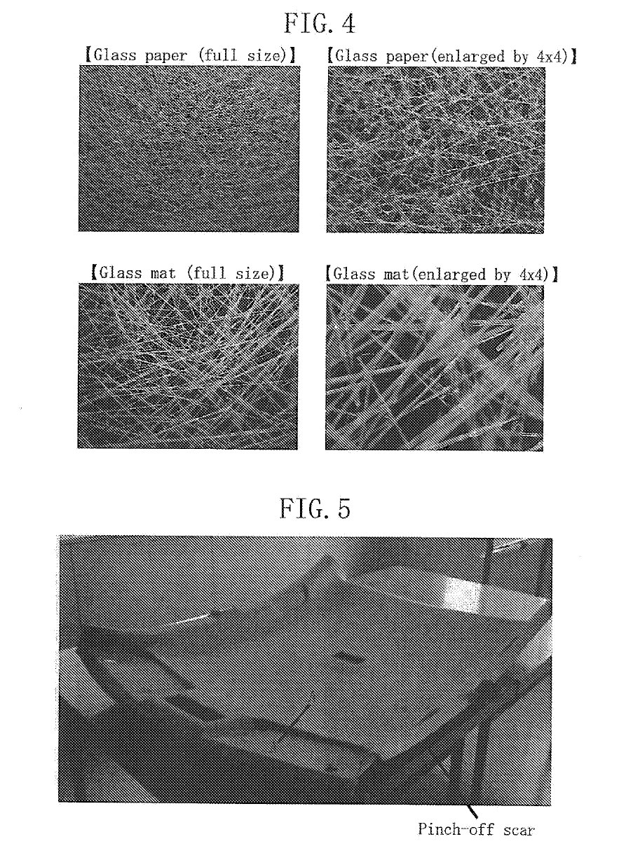

In comparison of Example 1 with Comparative Example 1 and of Examples 2, 3, 4 with Comparative Examples 2 and 3, the weight of the glass fibers for reinforcement was reduced, thereby achieving weight reduction although strength is increased. The reason thereof might be as follows. The glass mat is formed with bundled glass fibers into which about 80 glass filaments are bundled, thereby resulting in fiber distribution which is locally thin and locally thick. Therefore, partial strength may be insufficient. In comparison, the glass filaments of the glass paper are distributed almost uniformly. Every part is uniform, and the filaments themselves, whose fibers are fine, are distributed. Thus, bonding surfaces of the fibers are in line contact with the urethane base material in the glass mats. By contrast, bonding surfaces of the fibers are almost in face contact therewith in the glass paper, thereby exhibiting satisfactory strength. FIG. 4 compares the glass paper having a basis weight of 27 g/m² in Example 1, and the glass mat having a basis weight of 100 g/m² in Comparative Example 1 in full size and enlarged scale of four by four. The above reason is also clear from FIG. 4.

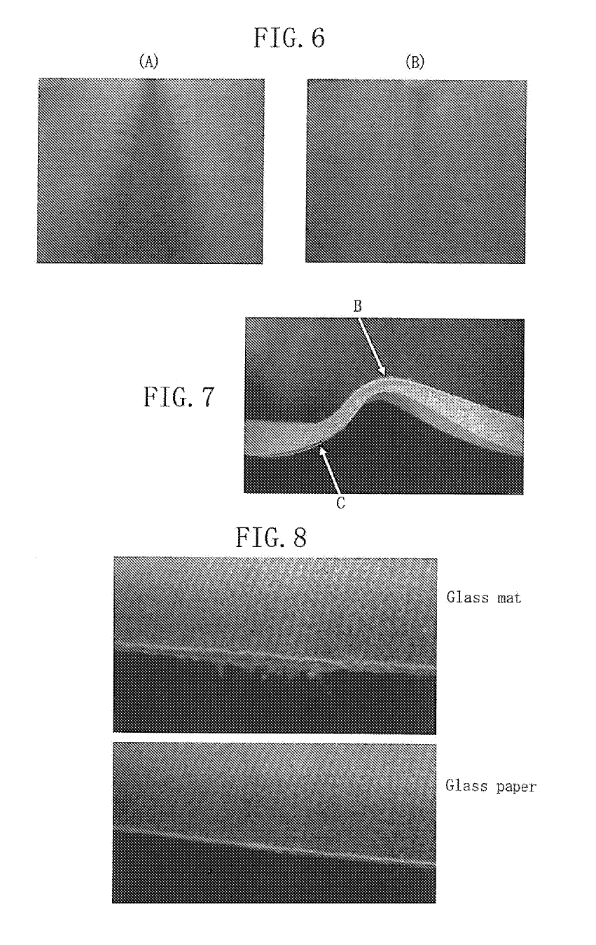

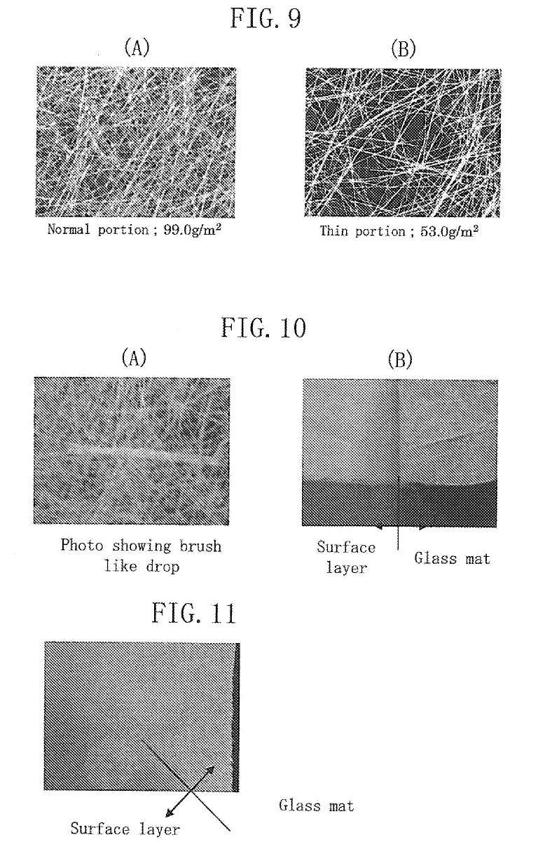

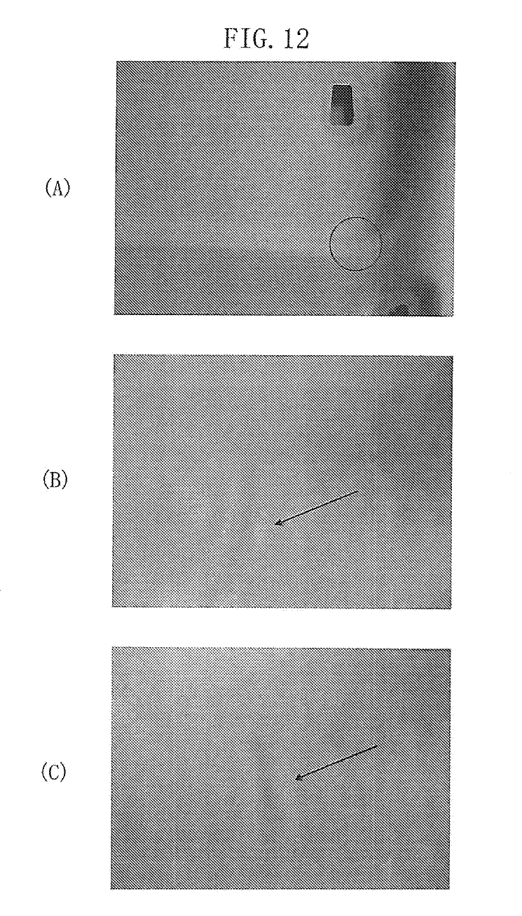

FIG. 5 is a photograph of a specific external appearance of the formed ceiling of Comparative Example 2. This shows considerably bent and deformed parts, such as mounting portions for a sun visor, an overhead console, assist grips, a room lamp, and the like, and bonding portions of a front pillar to a center pillar. Corrugation is formed in these portions. At a portion where remarkable corrugation is generated, the base material is broken, thereby resulting in disposal of to a component (unusable). This is because the use of the glass mat for reinforcement. The glass fiber bundles of about 80 fibers are scattered non-uniformly to form a partially strong portion. This prevents the fibers to skidding well to allow the fibers to bite the urethane base material. FIG. 6 is photos showing, as a typical example, a sun visor portion (portion corresponding to a cross section taken along the line A-A in FIG. 5), for example. Commercial value depends on the surface layer as a designed surface. Although a defect can be found when viewing a real component, it is very difficult to find out such a defect from its photograph (because surface asperities are covered with the elastic surface layer). Therefore, photographs of such a portion was willingly taken from the reverse side. FIG. 6(A) on the right shows glass corrugation of the glass mat in Comparative Example 1. FIG. 6(B) on the left shows the glass paper in Example 2. It is proved that no glass corrugation was formed in Example 2.

Further, FIG. 7 shows a cross section taken along the line A-A in a glass mat in Comparative Example 2. In FIG. 7, the upper side corresponds to the side of the surface layer, while the lower side corresponds to the side of the reverse layer. In association with tension in forming, glass corrugation tends to be generated more in a protruded portion (a portion B) than in a recessed portion (a portion C). Accordingly, in the glass mat as shown in FIG. 7, the mold is largely protruded from the reverse side of the protruding portion to reduce a mold clearance, thereby reducing as far as possible a step difference between a portion where glass fibers bite and a portion that they do not bite. It can be readily seen that the base material is extremely thin at this portion, which is not favorable in view of strength. In an extreme case, the base material of such a portion may be broken, and the formed component may be disposed.

In addition, even though the mold clearance is extremely reduced, corrugation is generated. This necessitates a so-called disguise for making asperities to be ignorable, in which the surface layer is raised by the tip end of a needle after forming to reduce the asperities of the surface layer. However, the disguise is performed manually, thereby remarkably reducing yield. It is noted that although glass corrugation is generated also at the recessed portion (the portion C) on the side of the surface layer, it is not so remarkable when compared with that at the portion B, and the mold clearance at that portion is more gentle than that at the portion B.

It is noted that the corrugation in FIG. 6 corresponds to the portion C in FIG. 7. If the mold clearance at the portion B in FIG. 7 is not so extremely reduced, the surface layer shows such an aspect.

The front, rear, right, and left edges of the ceiling called pinch-off scars are formed by trimming in one stroke by the same mold at the same time as forming a ceiling. In forming a ceiling, the materials are trimmed in one stroke at the same time as forming, rather than in different steps or two-step motion, with the extension of material and the like taken into consideration. For trimming, a blade is naturally attached to the mold. Accordingly, it is required to finely adjust timing when the blade is applied to the to-be-molded substance in a forming stroke. Therefore, it is not easy to adjust a mold having a blade widely ranging around substantially the entire periphery.

It is the prior art glass mat that makes such adjustment to be further difficult. In FIG. 8, the upper photograph shows the glass mat in Comparative Example 2, and the lower photograph shows the glass paper in Example 2. The component in Comparative Example 2 cannot be used as it is, and needs handwork, such as cutting using scissors, thereby remarkably reducing yield. By contrast, Example 2 can remarkably reduce the need of manual corrugation removal and cutting of such pinch-off scars by scissors, thereby increasing yields. In addition, it is unnecessary to extremely reduce the mold clearance for eliminating corrugation, thereby contributing to a reduction of disposal caused by breakage.

Further, a secondary advantage will be discussed herein. An adhesive is coated on a reinforcing material (conventionally, a glass mat) by a roll coater or the like in advance before forming. The adhesive (isocyanate) not only is cured by increasing temperature but also reacts with moisture to be cured. Therefore, the reinforcing material after being coated with the adhesive is stored in a refrigerator and is managed so that a reaction of the isocyanate is not caused until it is supplied to a line for forming. However, after being supplied to the line, the adhesive receives influence of temperature and humidity. Therefore, the material must be used within 1.5 to 2 hours in hot and humid summer.

By contrast, a rolled inner portion of the glass paper in the present invention, whose fibers are thicker than the glass mat, hardly receives influence of outer air. Therefore, the glass paper can be used in three to four hours. Further, a frequency of replacement of the rolls can be reduced.

The present invention can contribute to addressing environmental issues, such as a reduction in amount of disposal, a reduction in amount of disposed glass fibers themselves even if the trimmed area is the same, as described above.

The above example embodiment refers to glass paper formed with glass fiber filaments. The same advantages can be obtained in basalt paper formed with basalt fiber filaments. Therefore, an example embodiment thereof is omitted.

### INDUSTRIAL APPLICABILITY

The formed material for an interior component according to the present invention can be used as formed materials for automobile interior components, such as formed ceilings, formed door trims, rear package trays, floor materials, etc. for automobiles, for example.

### DESCRIPTION OF REFERENCE CHARACTERS

1 formed material for vehicle interior component
11 base material layer
12 first glass fiber reinforced layer
13 surface layer
14 second glass fiber reinforced layer
15 reverse layer

1. A formed material for a vehicle interior component, comprising:
a base material layer made of rigid urethane foam;
first and second fiber reinforced layers bonded on opposite sides of the base material layer;
a surface layer bonded on the exterior of the first fiber reinforced layer; and
a reverse layer bonded on the exterior of the second fiber reinforced layer,
wherein at least the first fiber reinforced layer is made of paper formed of fiber filaments,
a silane based treatment agent containing silane or a silane mixed agent with which urethane emulsion is mixed is used as a treatment agent for the paper, and
the paper is bonded to the base material layer with a urethane based adhesive.

2. The formed material of claim 1, wherein
the paper is made of an inorganic material.

3. The formed material of claim 2, wherein
the paper is made of paper of glass fiber filaments or basalt fiber filaments, and the first and second fiber reinforced layers are made of paper of glass fibers or basalt fibers.

4. The formed material of claim 1, wherein
the treatment agent for the paper is used in forming the fiber filaments, and the paper is formed with the treatment agent used for generating the fiber filaments.

5. The formed material of claim 1, wherein
the fiber filaments has a diameter of 5 to 25 μm.

6. The formed material of claim 1, wherein
the fiber filaments include long fibers having a length of 20 to 100 mm.

7. The formed material of claim 6, wherein
the long fibers having a length of 20 to 100 mm are included by at least one third in the fiber filaments.

8. The formed material of claim 1, wherein
the paper has a basis weight of 20 g/m² to 100 g/m².

9. The formed material of claim 1, wherein
the paper is formed by mixing chemical fibers of polyethylene of 3 to 20 weight % with the fiber filaments.

10. The formed material of claim 1, wherein
the paper of the fiber filaments is formed by a wet process.

11. The formed material of claim 1, wherein
the formed material for a vehicle interior component is a formed ceiling.
